(19) United States
(12) Patent Application Publication
(10) Pub. No.: US 2012/0103892 A1
(43) Pub. Date: May 3, 2012

(54) SEPARATION MODULE

(75) Inventors: Philip Paul Beauchamp, Rexford, NY (US); Ramasamy Thiyagarajan, Louisville, KY (US); Anubhav Kumar, Bangalore (IN); Todd Alan Anderson, Niskayuna, NY (US)

(73) Assignee: GENERAL ELECTRIC COMPANY, SCHENECTADY, NY (US)

(21) Appl. No.: 12/913,871

(22) Filed: Oct. 28, 2010

(51) Int. Cl. B01D 61/08; B32B 38/00; B32B 37/16

(52) U.S. Cl. 210/321.72; 156/306.6; 156/185

(57) ABSTRACT

A separation module utilizing a feed spacer and a method for forming such a separation module are provided. A gasket comprising a flexible waterproof material is disposed on at least part of one or more edges of the feed spacer. A membrane layer is disposed on a first surface of the feed spacer. A permeate carrier is disposed on a surface of the membrane element opposite the feed spacer.

### BACKGROUND

Embodiments presented herein relate to a separation module and more particularly to reverse osmosis, forward osmosis, and physical filtration modules. Physical filtration can include micro, ultra and nano filtration processes.

Membrane modules are widely used for separating fluids with dissolved and suspended organic and inorganic solids. Processes used for this purpose can include reverse osmosis, forward osmosis, and physical filtration. In reverse osmosis, a feed solution such as, but not limited to brackish or impure water, sea water, and so forth, is passed through a semi-permeable membrane at a pressure higher than the osmotic pressure of the feed water. A permeate, for example, purified water is obtained on the other side of the semi-permeable membrane.

In forward osmosis, water from a feed solution such as, but not limited to brackish or impure water, seawater, and so forth, is drawn through a semi-permeable membrane due to the osmotic pressure difference between the feed solution and a draw solution. The draw solution therefore exits the separation module with a reduced concentration of draw chemical due to the increased percentage of water.

Lastly, for the physical filtration processes such as micro-, ultra- and nano-filtration, a feed solution containing suspended solids is introduced to the separation module at higher pressure than exists in the permeate channels of the module. Water flows through the pores of the separation membrane and exits the separation module through a permeate channel.

In the above processes for reverse osmosis, forward osmosis and physical filtration, the feed channels are typically defined by geometry of the module and more typically, by adhesives that are disposed on the edges of the feed spacer materials. Though channels defined by this method have been shown, a robust implementation has yet to be achieved. For example, the adhesive adheres to the membrane face which in the case of RO or FO is typically very thin on the order of 100 nm. When the feed channel is pressurized above the pressure of the permeate channel, a stress concentration at the membrane-adhesive joint develops and generally results in a tear in the membrane. The tear in the membrane then results in decreased purification. In other cases, where the feed pressures are not high enough to immediately tear the membrane at the stress concentration, handling, pressure fluctuations or periodic cycling can have similar effect on the membrane tearing.

In other cases, end caps, or end potting can be disposed on the ends of the modules to define the feed solution flow path. Lastly, chemical joining of the layers can also be used to define the feed solution flow path within the feed channel. However, such joints may be susceptible to leaks at high pressures of the feed. Further, processes involved in producing chemical joints may be expensive and time consuming. Variations in the thickness of each feed channel along the flow direction may also not be possible in such cases. The chemically joined edges may also cause damage to the layer of membrane element. Moreover, chemical joints may not provide additional rigidity to the layer of permeate carrier. In spiral wound modules, it may also be difficult to roll chemically joined leaves around the core.

Therefore there is a need for a feed spacer gasket technology that overcomes these and other shortcomings of the prior art.

### BRIEF DESCRIPTION

A separation module utilizing a feed spacer and a method for forming such a separation module are provided. A gasket comprising a flexible waterproof material is disposed on at least part of one or more edges of the feed spacer. A membrane layer is disposed on a first surface of the feed spacer. A permeate carrier is disposed on a surface of the membrane element opposite the feed spacer.

Several embodiments of a separation module are provided. The membrane module includes at least one layer of a permeate carrier, at least one layer of a membrane element, and at least one layer of a feed spacer. The membrane module further includes at least one layer of a feed spacer wherein edges of the feed spacer are at least partly covered by one or more strips of a waterproof flexible material. A seal is formed between the membrane element and the feed spacer, wherein the one or more strips of the waterproof flexible material is compressed against the membrane element to form the seal. The flexible waterproof material may be compressed against the membrane element either by winding the membrane stack around a central core, or by compressing the flexible waterproof material against the membrane element using a suitable frame and plate assembly.

A method for fabricating a separation module is provided. The method includes providing a feed spacer and impregnating at least part of one or more edges of the feed spacer with a flexible waterproof material. The method further includes providing a membrane element on one side of the feed spacer, and providing a permeate carrier on the opposite side of the membrane element. In several embodiments, the method further includes winding the feed spacer, the membrane element, and the permeate carrier around a core. The flexible waterproof material compresses against the membrane element to form a seal in the feed channel.

### BRIEF DESCRIPTION OF DRAWINGS

FIG. 1 illustrates the sequence of layers of materials, according to an embodiment;

FIG. 2 illustrates the waterproof gasket, according to several embodiments;

FIG. 3 is a cross section view of a membrane stack of a separation module, according to one embodiment;

FIG. 4 is a cross section view of a membrane stack of a separation module, according to another embodiment;

FIG. 5 illustrates a membrane stack of a separation module, according to one embodiment;

FIG. 6 illustrates a membrane stack of a separation module, according to another embodiment;

FIG. 7 illustrates a membrane stack of a separation module, according to yet another embodiment; and

FIG. 8 is a profile plot of gasket thickness against a length of the feed spacer, according to various embodiments.

### DETAILED DESCRIPTION

Various embodiments presented herein will be described in detail below with reference to accompanying drawings. It will be apparent, however, that these embodiments may be practiced without some or all of these specific details. In other instances, well known process steps or elements have not been described in detail in order not to unnecessarily obscure the description of the embodiments. The following example embodiments and their aspects are described and illustrated in conjunction with apparatuses, methods, and systems which are meant to be illustrative examples, not limiting in scope.

Embodiments presented herein describe a feed spacer and a separation module employing the feed spacer. Depending on the particular embodiment, the separation module can be used for reverse osmosis, forward osmosis or physical filtration applications. Exemplary embodiments for the applications will become evident through the descriptions provided with the accompanying figures.

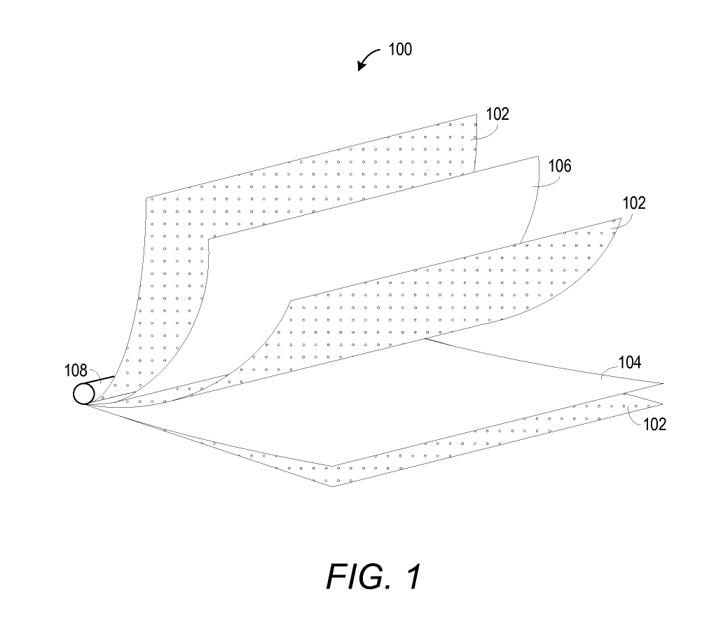

FIG. 1 illustrates an example sequence of materials in a typical spiral wound separation module 100 applicable for reverse osmosis, forward osmosis and physical filtration, according to various embodiments. The separation module includes one or more layers of membrane element 102 disposed between one or more layers of feed spacer 104 and one or more layers of permeate carrier 106. The layers of the membrane elements 102, the feed spacer 104, and the permeate carrier 106 are wound around a central core 108. The central core 108 may include separate channels for the feed solution, the permeate and the retentate. The sequence of layers may be repeated any number of times depending on the desired geometry of the separation module.

The basic function of the spiral wound separation module 100 for reverse osmosis, forward osmosis, and physical filtration is described in the following paragraphs.

Reverse Osmosis

The feed solution may be pumped through the feed spacer 104 at high pressure, usually 2-17 bar (30-250 PSI) for brackish water, and 40-70 bar (600-1000 PSI) for seawater. Due to the pressure of the feed solution, the feed solution flowing through the feed spacer 104 is forced into the membrane element 102. The permeate, for example, purified water, may pass through the membrane element 102 and collect in the permeate carrier 106. The permeate carrier 106 carries the permeate to a permeate discharge port. The retentate, for example, brine, does not pass through the membrane element 102, and remains in the feed spacer 104. The feed spacer 104 carries the retentate to a retentate discharge port.

Physical Filtration

The feed solution may be pumped through the feed spacer 104 at high pressure. Due to the pressure of the feed solution, the feed solution flowing through the feed spacer 104 is forced into the membrane element 102. The filtrate may pass through the membrane element 102 and collect in the permeate carrier 106. The permeate carrier 106 carries the filtrate to a filtrate discharge port. The impure feed solution does not pass through the membrane element 102, and remains in the feed spacer 104. The feed spacer 104 carries the impure feed solution to a impure feed discharge port.

Forward Osmosis

The feed solution may be pumped through the feed spacer 104, and a suitable draw solution may be pumped through the permeate carrier 106. Due to the osmotic pressure gradient across the membrane element 102, a net flow of permeate from the feed solution in the feed spacer 104 to the draw solution in the permeate carrier 106 occurs. The permeate may pass through the membrane element 102 and collect in the permeate carrier 106. The permeate carrier 106 carries the permeate to a permeate discharge port. The permeate may then optionally be subject to a second separation process such as reverse osmosis, or draw solute separation techniques. The retentate does not pass through the membrane element 102, and remains in the feed spacer 104. The feed spacer 104 carries the retentate to a retentate discharge port.

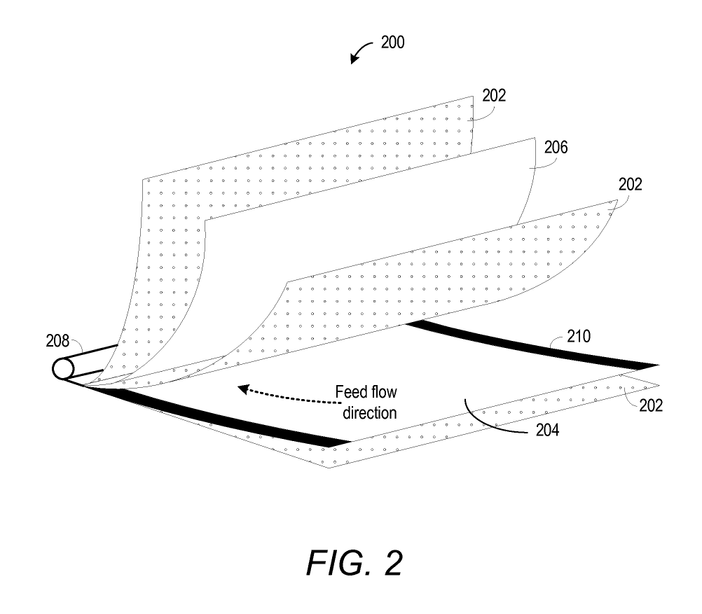

FIG. 2 illustrates flexible waterproof gaskets impregnated on a feed spacer in the separation module, according to several embodiments. Membrane stack 200 may be employed in several different separation module configurations for the reverse osmosis, forward osmosis and physical filtration processes. The membrane stack 200 includes one or more layers of membrane element 202 disposed between one or more layers of feed spacer 204 and one or more layers of permeate carrier 206. A flexible waterproof gasket 208 is disposed on the lateral edges of the feed spacer that are perpendicular to the axis of a cylindrical separation module. The flexible waterproof gasket 208 may preferably be disposed on the feed spacer 204 prior to assembly of the membrane stack 200. The layers of the membrane elements 202, the feed spacer 204, and the permeate carrier 206 are wound around a central core 210. Due to winding of the membrane elements 202, the feed spacer 204, and the permeate carrier 206 around the central core 210, a seal is formed between the membrane elements 202 and the flexible waterproof gasket 208 due to compression. The seal thus defines a feed solution channel between the membrane elements 202 adjacent to the feed spacer 204.

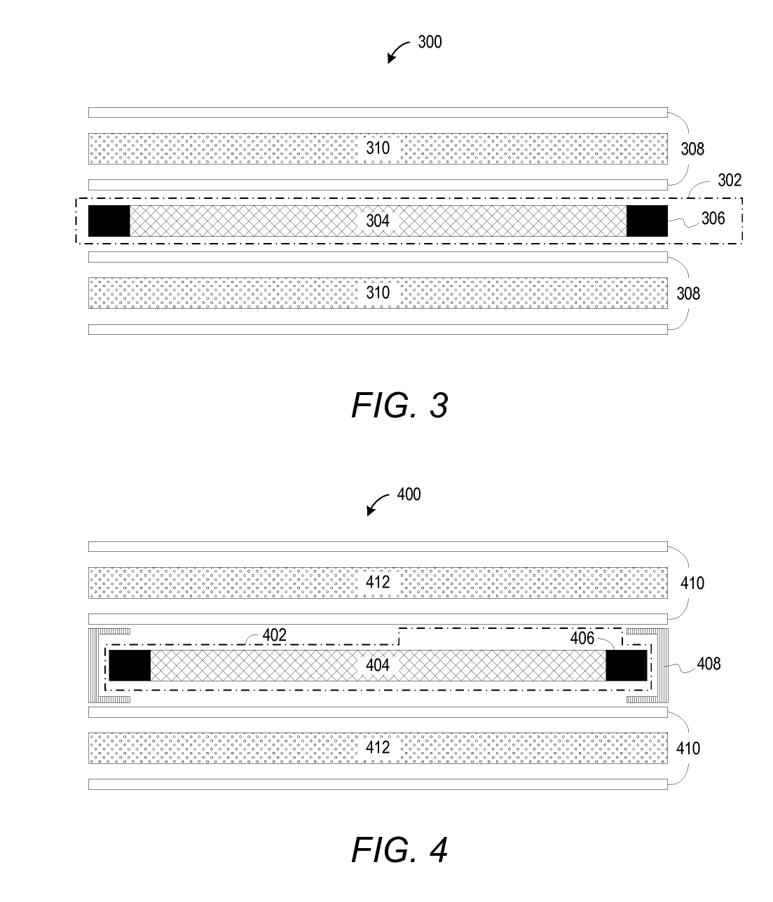

FIG. 3 illustrates a cross section view 300 of an exemplary membrane stack, according to one embodiment. The membrane stack includes a feed spacer 302. The feed spacer 302 includes an open mesh structure 304. The lateral edges of the open mesh structure 304 may be covered, at least partly, with one or more flexible waterproof gaskets 306. The flexible waterproof gasket may be made of a rubbery material having a glass transition temperature below typical operating temperatures (5-6 degree Centigrade) of the separation module. The flexible waterproof gasket may be made of materials such as including thermoplastics and thermosets. Example materials include, without limitation, hot melt adhesives such as ethylene-vinyl acetate (EVA) copolymers, ethylene-acrylate copolymers such as ethylene-vinylacetate-maleic anhydride, ethylene-acrylate-maleic anhydride, terpolymers, ethylene n-butyl acrylate, ethylene-acrylic acid, and ethylene-ethyl acetate; polyolefins such as low density polyethylene (LDPE), high density polyethylene (HDPE), polypropylene, polybutene-1, polyamides and polyesters, polyurethanes such as thermoplastic polyurethanes and reactive urethanes; styrene block copolymers including styrene-butadiene-styrene, styrene-isoprene-styrene, styrene-ethylene/butylene-styrene, styrene-ethylene/propylene block copolymers, polycaprolactone, polycarbonates, fluoropolymers, silicone rubbers, and thermoplastic elastomers. In particular, ethylene-vinyl acetate (EVA) may be used to form the flexible waterproof gaskets 306. In the embodiment illustrated in FIG. 3, the lateral edges of the open mesh structure 304 may be covered completely with one or more flexible waterproof gaskets 306.

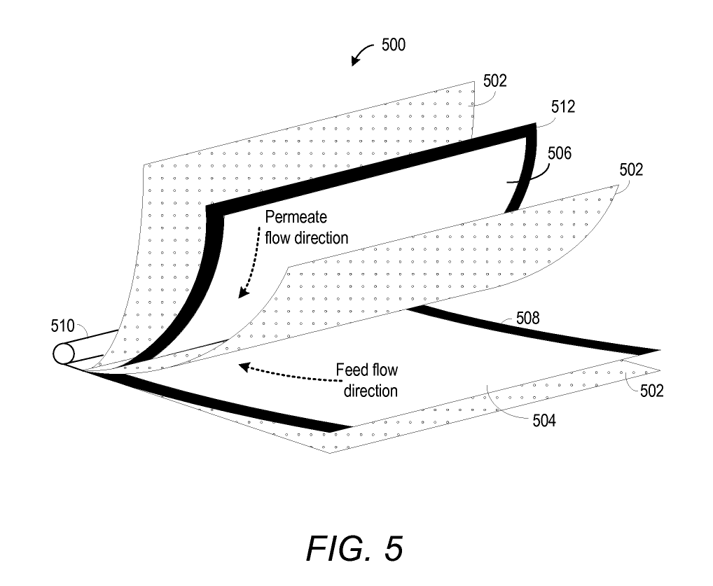

The flexible waterproof gasket 306 may be disposed on the open mesh structure 304 using any suitable technique. In one embodiment, the open mesh structure 304 is impregnated with a hot thermoplastic material, such as EVA. The feed spacer 302 is then stacked with one or more membrane elements 308, and one or more permeate carriers 310 to form the membrane stack for a separation module. Compression of the flexible waterproof gasket 306 against the membrane elements 308 effectively forms a seal for the feed channel. In several embodiments (such as the embodiments described in conjunction with FIG. 5) for spiral wound and flat module configurations, the pressure difference between the feed channel and the applied feed solution pressure is small. In such embodiments the flexible waterproof gaskets 306 easily seal the feed channel.

FIG. 4 illustrates a cross section view 400 of an exemplary membrane stack, according to one embodiment. The membrane stack includes a feed spacer 402. The feed spacer 402 includes an open mesh structure 404. The lateral edges of the open mesh structure 404 may be covered, at least partly, with one or more flexible waterproof gaskets 406. Example materials and techniques suitable for forming the flexible waterproof gasket 406 are described in conjunction with FIG. 3. The membrane stack of FIG. 4 further includes an adhesive 408 applied between the flexible waterproof gasket 406 and the adjacent membrane elements 410. The adhesive 408 may be applied on the flexible waterproof gasket 406 and around the outer edges of the flexible waterproof gasket 406 to improve the sealing.

In embodiments for spiral wound and flat module configurations, where the pressure difference between the feed channel and the applied feed solution pressure is large, the adhesive 408 may further bond the feed spacer 402 to a membrane element 410. Suitable materials for the adhesive 408 form a bond with the flexible waterproof gasket 406 as well as with the membrane element 410. One example of a suitable adhesive is a thermosetting urethane.

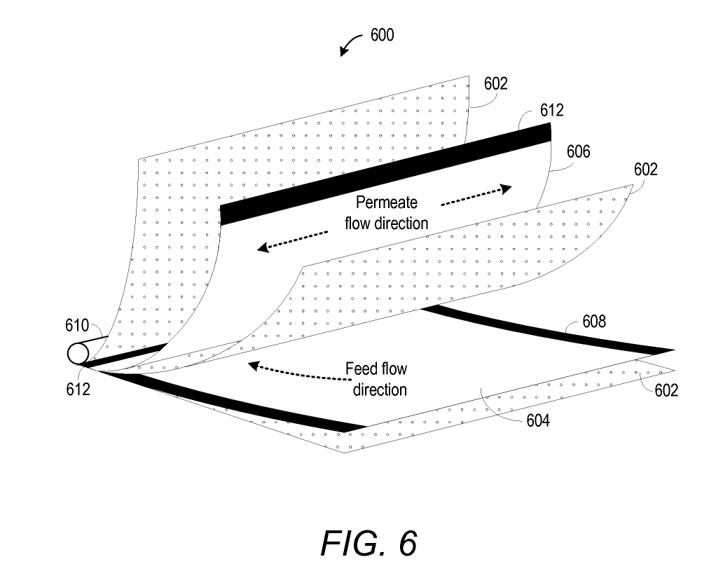

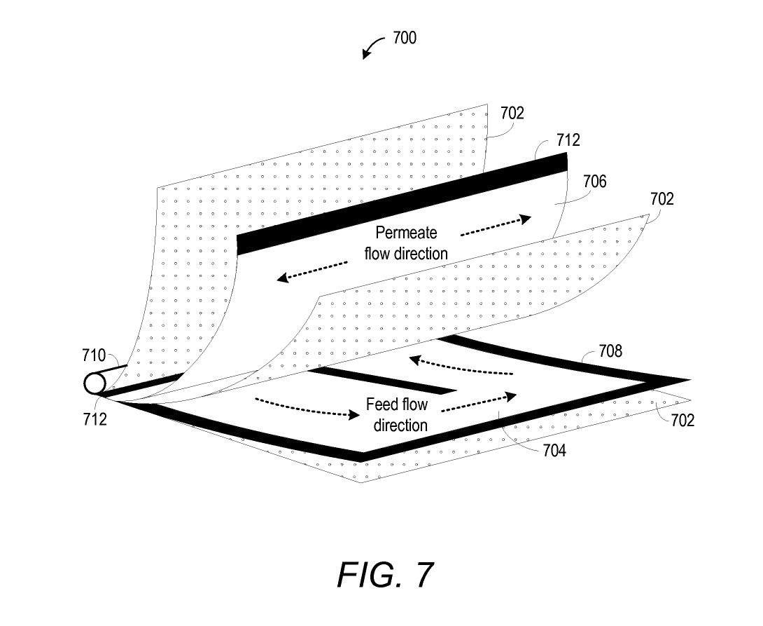

Although FIGS. 2, 3, and 4 illustrate flexible waterproof gaskets disposed on lateral edges of the open mesh structure, in various other embodiments, flexible waterproof gaskets may also be is disposed on the axial edges of the open mesh structure, particularly the axial edge distal from the central core. Such embodiments are described in conjunction with FIGS. 6 and 7.

FIG. 5 illustrates a membrane stack 500 for use in a separation module, according to one embodiment. Membrane stack 500 may be suitable for use in a spiral flow separation module. The membrane stack 500 includes one or more layers of membrane element 502 disposed between one or more layers of feed spacer 504 and one or more layers of permeate carrier 506. A flexible waterproof gasket 508 is disposed on the lateral edges of the feed spacer 504 at the axial ends of a cylindrical separation module. Membrane stack 500 may be employed in several different separation module configurations for the reverse osmosis, and physical filtration processes.

The feed solution may flow spirally inwards from an inlet disposed on a circumferential edge of the spiral flow separation module, into the central core 510. Alternatively, the feed solution may flow spirally outwards from the central core 510 into an outlet disposed on a circumferential edge of the spiral flow separation module. As the feed solution flows through the feed spacer 504, the membrane element 502 recovers a permeate. The permeate flows across the membrane element 502 into the permeate carrier 506. The permeate then flows spirally inwards from a circumferential edge of the permeate carrier 506, into the central core 510.

Similar to the flexible waterproof gasket 508 disposed on the feed spacer 504, the permeate carrier 506 may also include a flexible waterproof gasket 512 disposed thereon. The flexible waterproof gasket 512 may form a seal, the seal defining a permeate channel between the membrane elements 502 adjacent to the permeate carrier 506.

FIG. 6 illustrates a membrane stack 600 for use in a separation module, according to one embodiment. Membrane stack 600 may be suitable for use in a cross permeate flow separation module. The membrane stack 600 includes one or more layers of membrane element 602 disposed between one or more layers of feed spacer 604 and one or more layers of permeate carrier 606. The feed spacer 604 further includes a flexible waterproof gasket 608 disposed on the lateral edges of the feed spacer 604 at the axial ends of a cylindrical separation module. Membrane stack 600 may be employed in several different separation module configurations for the reverse osmosis, forward osmosis and physical filtration processes.

The feed solution may flow spirally inwards from an inlet disposed on a circumferential edge of the cross permeate flow separation module, into the central core 610. Alternatively, the feed solution may flow spirally outwards from the central core 610 into an outlet disposed on a circumferential edge of the cross permeate flow separation module. As the feed solution flows through the feed spacer 604, the membrane elements 602 recover a permeate. The permeate flows across the membrane element 602 into the permeate carrier 606. The permeate then flows through the permeate carrier 606 axially out towards the axial ends of the cross permeate flow separation module. The permeate may flow out axially through one end, or both ends. In one embodiment, the cross permeate flow separation module may be used for forward osmosis process. The draw solution flows axially through the permeate carrier 606.

Flexible waterproof gaskets 612 disposed on the permeate carrier 606 may form a seal, similar to the seal formed by the flexible waterproof gasket 608. The flexible waterproof gaskets 612 defining a permeate/draw channel between the membrane elements 502 adjacent to the permeate carrier 506, and direct the flow of the permeate/draw solution axially through the cross permeate flow separation module.

FIG. 6 illustrates a cross permeate flow separation module having a spiral feed flow, and an axial permeate/draw solution flow. However, it should be appreciated that flow paths of the permeate/draw solution and the feed solution may be reversed. In other words, the cross permeate flow separation module may have a spiral permeate/draw solution flow and an axial feed flow. In such embodiments, the feed spacer 604 may have disposed thereon a flexible waterproof gasket along the axial edges parallel of the cross permeate flow separation module, similar to flexible waterproof gasket 612. On the other hand, the permeate carrier 606 may have disposed thereon a flexible waterproof gasket along the lateral edges of the cross permeate flow separation module, similar to flexible waterproof gasket 608.

FIG. 7 illustrates a membrane stack 700 for use in a separation module, according to one embodiment. Membrane stack 700 may be employed in several different separation module configurations for the reverse osmosis, forward osmosis and physical filtration processes. The membrane stack 700 includes one or more layers of membrane element 702 disposed between one or more layers of feed spacer 704 and one or more layers of permeate carrier 706. The feed spacer 704 further includes a flexible waterproof gasket 708 disposed on the lateral edges and the distal axial edge of the feed spacer 704. The feed spacer 704 also includes a flexible waterproof gasket 710 disposed perpendicular to the axis of the cylindrical separation module. The flexible waterproof gasket 710 may be disposed substantially mid way between the lateral edges of the feed spacer 704. The flexible waterproof gasket 710 may not extend up to the distal axial edge of the feed spacer 704. The flexible waterproof gasket 708 and the flexible waterproof gasket 710 define a U-shaped feed channel for feed solution flow.

The feed solution may flow into the central core 712 from an inlet at one axial end of the central core 712. The feed solution flows into the feed spacer 704 and spirally outwards to the end of the feed spacer 704. The feed solution turns the corner at the distal end of the flexible waterproof gasket 710 and flows spirally inwards to the central core 712. The feed solution then drains out of an outlet at the opposite axial end of the central core 712.

As the feed solution flows through the feed spacer 704, the membrane elements 702 recover a permeate. The permeate flows across the membrane element 702 into the permeate carrier 706. The permeate then flows through the permeate carrier 706 axially out towards the axial ends of the cross permeate flow separation module. The permeate may flow out through one axial end, or both axial ends. In one embodiment, the separation module may be used for forward osmosis process. The draw solution flows axially through the permeate carrier 706.

Flexible waterproof gaskets 712 disposed on the permeate carrier 706 may form a seal, similar to the seal formed by the flexible waterproof gasket 708. The flexible waterproof gaskets 712 defining a permeate/draw channel between the membrane elements 702 adjacent to the permeate carrier 706, and direct the flow of the permeate/draw solution axially through the separation module.

Similar to the embodiment illustrated in FIG. 6, the flow paths of the permeate/draw solution and the feed solution may be reversed. In other words, the separation module may have a spiral permeate/draw solution flow and an axial feed solution flow. In such embodiments, the feed spacer 704 may have disposed thereon a flexible waterproof gasket along the proximal and distal axial edges similar to flexible waterproof gasket 712. On the other hand, the permeate carrier 606 may have disposed thereon a flexible waterproof gaskets configuration similar to flexible waterproof gaskets 708 and 710.

In some embodiments, the flexible waterproof flexible waterproof gaskets may allow variable height feed channels. Variable height feed channels may facilitate optimal interaction of the feed water with the semi-permeable membrane, while minimizing pressure drop through the feed channel.

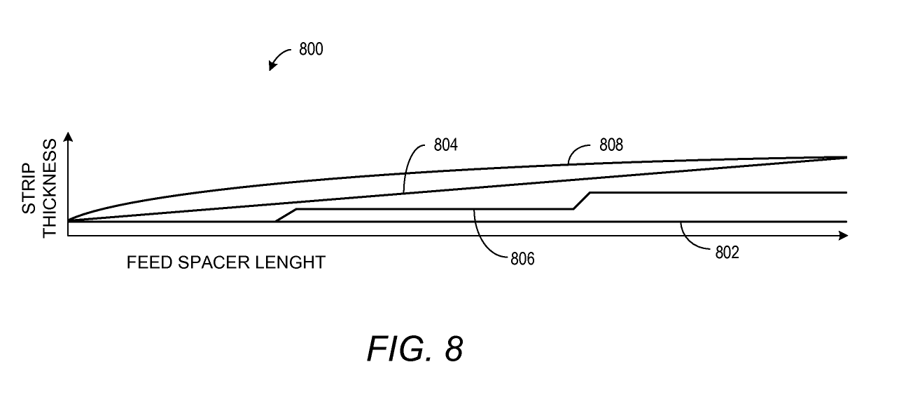

FIG. 8 illustrates a profile plot 800 of thickness of the flexible waterproof gasket against the length of the feed spacer, according to various embodiments. For spiral wound configurations, the length of the feed spacer is the spiral length measured from the central core. As would be apparent to one skilled in the art, the direction of the feed flow would determine the direction of the thickness gradient. Accordingly, the variation of the feed channel can be tailor for any of the feed flow configuration embodiments shown in FIGS. 2, 3, 4, 5 and 6.

Profile 802 is a straight line indicating that the thickness of the flexible waterproof gasket is constant throughout the length of the feed spacer. Thus the height of the feed channel remains unchanged as the feed water flows from the inlet to the core.

Profile 804 is a straight line indicating a linearly increasing thickness of the flexible waterproof gasket. The thickness is lowest at the end near the retentate outlet from the module, and highest at the end near the feed solution inlet. In other words, the height of the feed channel linearly decreases as the feed water traverses from the feed solution inlet to the retentate outlet.

Profile 806 is a step type profile indicating that the thickness of the flexible waterproof gasket increases in steps with the length of the feed spacer. In one example implementation, the profile 806 may provide a feed channel having a different height for every turn of the membrane stack. For implementations where the feed solution enters through an axial inlet port, the height of the feed channel for the outermost turn of the membrane stack would be highest, and the height of the feed channel for the innermost turn of the membrane stack would be lowest. Whereas, for implementations where the feed solution enters through central core, the height of the feed channel for the innermost turn of the membrane stack would be highest, and the height of the feed channel for the outermost turn of the membrane stack would be lowest.

Profile 808 is a curve indicating that the thickness of the flexible waterproof gasket increases non-linearly and gradually with the length of the feed spacer. In one example implementation, the profile 808 may become substantially flat after a predefined length of the feed spacer.

The thickness profile of the flexible waterproof gasket may be determined using factors such as, but not limited to, the decrease in feed volume due to purification of the feed water as it flows through the feed channel. Such a decrease in feed volume reduces the feed solution velocity in a fixed height feed channel. Thus, the thickness profile may be selected based on the required velocity gradient from the feed solution inlet to the retentate discharge port, without changing the operating parameters of the pump used to pressurize the feed water. Maintaining the feed solution velocities may also decrease concentration polarization and maintain mass transport across the membrane, thus improving efficiency of the spiral feed flow RO element.

The foregoing description includes various embodiments of the separation module in a spiral wound configuration. However, the teachings of these embodiments may equally be applied to flat-type separation modules. In particular, the embodiments described in conjunction with FIG. 6 may readily be practiced in a separation module in the flat-type configuration. Flat-type separation modules include a membrane stack similar to that described in conjunction with FIG. 1. However, the membrane stack is laid flat on a frame or plate assembly, rather than being wound around a central core. Various arrangements of plates and frames may be used to compress the flexible waterproof gaskets against the membrane elements to effectively seal the feed channels. Further, as described in conjunction with FIG. 8, the flexible waterproof gaskets may have a thickness varying along the longitudinal length of the feed spacer. Flat-type configurations of separation modules typically include feed inlet ports and retentate discharge ports connected to the feed carriers, and permeate discharge ports connected to the permeate carriers.

Although specific implementations and application areas are described in conjunction with the embodiments presented herein, such description is solely for the purpose of illustration. Persons skilled in the art will recognize from this description that such embodiments may be practiced with modifications and alterations limited only by the spirit and scope of the appended claims.

1. A separation module comprising:
a feed spacer;
a gasket comprising a flexible waterproof material disposed on at least part of one or more edges of the feed spacer;
a membrane layer disposed on a first surface of the feed spacer; and
a permeate carrier disposed on a surface of the membrane element opposite the feed spacer.

2. The separation module of claim 1, wherein the gasket comprises a thermoplastic polymer.

3. A separation module according to claim 1, additionally comprising a core element, and wherein the feed spacer, the membrane element, and the permeate carrier are radially disposed around the core element.

4. A separation module according to claim 1, wherein a seal is formed by compression of the gasket against the membrane element.

5. A separation module according to claim 1, wherein the waterproof flexible material is at least partly disposed on axial edges of the feed spacer.

6. A separation module according to claim 1, wherein thickness of the flexible waterproof material varies along a length of the feed spacer.

7. A separation module according to claim 1 further comprising an adhesive material between the gasket and the membrane element.

8. A separation module according to claim 1, wherein the feed spacer comprises an open mesh structure.

9. A reverse osmosis system comprising one or more separation modules according to claim 3.

10. A forward osmosis system comprising one or more separation modules according to claim 3.

11. A physical filtration system comprising one or more separation modules according to claim 3.

12. A method for fabricating a separation module, the method comprising:
providing a feed spacer;
impregnating at least part of one or more edges of the feed spacer with a flexible waterproof material;
disposing a membrane element on the feed spacer; and
disposing a permeate carrier on a surface of the membrane element opposite the feed spacer.

13. The method of claim 12, additionally comprising winding the feed spacer, the membrane element, and the permeate carrier radially around a core.

14. The method of claim 12, additionally comprising compressing the flexible waterproof material to form a seal.

15. The method of claim 12, additionally comprising disposing a second membrane element on a surface of the permeate carrier opposite the first membrane element.

16. The method of claim 12, additionally comprising applying an adhesive between the flexible waterproof material and the membrane element.

17. The method of claim 12, additionally comprising disposing a thermosetting polymer between the flexible waterproof material and the membrane element.
